(19) United States
(12) Patent Application Publication
(10) Pub. No.: US 2010/0148599 A1
(43) Pub. Date: Jun. 17, 2010

(54) Magnet window

(76) Inventor: Mark Anthony Pensiero, Arvada, CO (US)

Correspondence Address: Mark A. Pensiero, 6230 Quay St., Arvada, CO, 80003, US

(21) Appl. No.: 12/316,859

(22) Filed: Dec. 17, 2008

Related U.S. Application Data
(60) Provisional application No. 61/008,486, filed on Dec. 20, 2007.

(51) Int. Cl. H02K 37/02; H02N 11/00

(52) U.S. Cl. 310/46; 415/916

(57) ABSTRACT

A magnet shield that has openings to expose or hide magnets from each other. An actuator or indexing motor that moves the magnet shield at a desired event. An assembly combining a magnet shield and an actuator.

### CROSS-REFERENCE TO RELATED APPLICATIONS

This invention claims the benefit of U.S. Provisional Application Ser. No. 61/008,486, filed Dec. 20, 2007.

### TECHNICAL FIELD

The present invention relates to the generation of energy. In a more specific aspect, this invention relates to an apparatus for generating energy.

In this application, the term “energy” will be understood to refer to the capacity for doing work, whether directly or as in a direct drive assembly or indirectly as in a stored condition. Additionally, in this application, the term “generating energy” will be understood to refer to the conversion or use of magnetic energy to generate mechanical force and the conversion of magnetic energy into other forms of energy including electrical or kinetic energy.

### BACKGROUND OF THE INVENTION

Energy can be used in a multitude of ways, such as automotive and other engines, mechanisms for opening and closing, systems for moving objects from one place to another, etc. As energy is a valuable and required commodity for today's world, many attempts have been made to generate energy in an efficient and cost effective process.

Although many apparatus and processes have been developed to generate energy for specific applications, there continues to be a need in this industry for an effective, inexpensive and reliable apparatus for generating energy.

### SUMMARY OF THE INVENTION

Briefly described, the present invention provides an apparatus for generating energy by effective, inexpensive and reliable means. The energy generated by this invention can be used in many applications.

The present invention also provides an effective and reliable process for the generation (i.e., production) of energy.

Accordingly, an object of this invention is the generation of energy.

Another object of this invention is the generation of energy which can be used directly.

Another object of this invention is the generation of energy which can be used indirectly.

Another object of this invention is to provide an apparatus for generating energy.

Another object of this invention is to provide an apparatus for use as an engine or motor.

Another object of this invention is to provide an apparatus for use as a rotary engine.

Another object of this invention is to provide an apparatus which generates a long term supply of energy.

Another object of this invention is to provide an apparatus which is compatible with various forms of engines and motors, such as battery and solar powered engines and motors.

Another object of this invention is to provide an apparatus in which magnetic fields can be harnessed in an efficient manner.

Another object of this invention is to provide and apparatus in which magnetic fields can be harnessed in an efficient manner to produce lateral force.

Another object of this invention is to provide an apparatus which converts stored energy into kinetic energy.

Still another object of this invention is to provide a process for generating energy.

Still another object of this invention is to provide a process which can be used in an engine or motor.

Still another object of this invention is to provide a process which can be used in a rotary engine.

Still another object of this invention is to provide a process which generates a long term supply of energy.

Still another object of this invention is to provide a process which can be used in various forms of engines and motors, such as battery and solar powered engines and motors.

Still another object of this invention is to provide a process in which magnetic fields can be harnessed in an efficient manner.

Still another object of this invention is to provide a process in which magnetic fields can be harnessed in an efficient manner to produce lateral force.

Still another object of this invention is to provide a process for converting stored energy unto kinetic energy.

These and other objects, features and advantages of this invention will become apparent from the following detailed description.

### BRIEF DESCRIPTION OF THE DRAWINGS

FIG. 1 is a view of one configuration of the apparatus of this invention.

FIG. 2 is a view of yet another configuration of the apparatus of this invention.

FIG. 3 is a view of yet another configuration of the apparatus of this invention.

FIG. 4 is a view of the portion of FIG. 3 shown in a dotted circle.

FIG. 5 is a view of one configuration of the apparatus of this invention interacting with a simple mechanism. FIG. 1 is shown in a dotted circle.

FIG. 6 is a view of yet another configuration of the apparatus of this invention interacting with yet another simple mechanism. FIG. 1 is shown in a dotted circle.

FIG. 7 is a view of yet another configuration of the apparatus of this invention.

### DETAILED DESCRIPTION OF THE INVENTION

The present invention relates to an apparatus for generating or producing energy. More specifically, the apparatus of this invention comprises:

A. an iron or steel shield movable in a clockwise, counterclockwise or linear direction and having at least one window or slot cut out of or into it, also referred to herein as a magnet window;

B. an actuator, indexing motor or mechanical link to move the iron or steel shield at a desired event;

an electrical switch or mechanical trigger that is timed to control an actuator, indexing motor or mechanical link at any time prior to or, after any desired event;

C. an actuator, indexing motor or mechanical link connecting rod;

D. a iron or steel shield return spring;

E. fixed position or moveable magnets;

F. assembly structure and supports

G. one or more slip, lock, sleeve or linear bearings;

H. one or more connecting shafts for rotating or linear movement;

I. one or more power rods;

J. one or more connecting rods;

K. one or more flywheels;

L. one or more timing belts, chains or gears.

M. one or more moveable magnet guides.

This invention also provides a process for generating energy in which the process uses an apparatus as described in the proceeding paragraph.

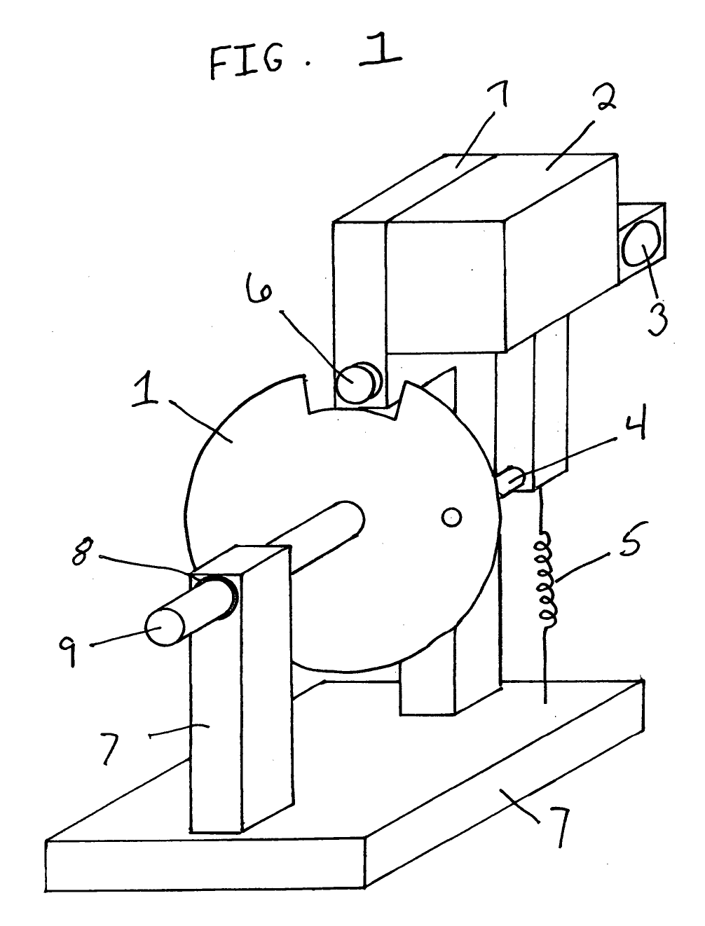

A preferred configuration of the apparatus of the present invention is shown in FIG. 1.

Referring now to the drawings, in which like numbers represent like elements, FIG. 1, shows a view of a preferred embodiment of this invention in which the apparatus comprises a movable iron or steel shield rotor 1 having one or more notches cut into the outer edge. The iron or steel shield rotor 1 is mounted to connecting shaft 9 which is mounted to sleeve bearing 8 which is connected to assembly structure 7. This preferred configuration allows rotational movement of iron or steel shield 1.

As shown in FIG. 1 affixed to an assembly structure 7 is a fixed magnet 6 that can be shielded or exposed by an iron or steel shield rotor 1. The iron or steel shield rotor 1 is moved by an actuator, indexing motor or mechanical link 2. The iron or steel shield rotor 1 is connected to an actuator, indexing motor or mechanical link 2 by an actuator, indexing motor or mechanical link connecting rod 4. A return spring 5 is used to return the iron or steel shield rotor 1 to its disengaged position when the actuator, indexing motor or mechanical link 2 is disengaged.

As shown in FIG. 1 an electrical switch or mechanical trigger 3 is timed to control the actuator, indexing motor or mechanical link 2 at any time prior to or after any desired event.

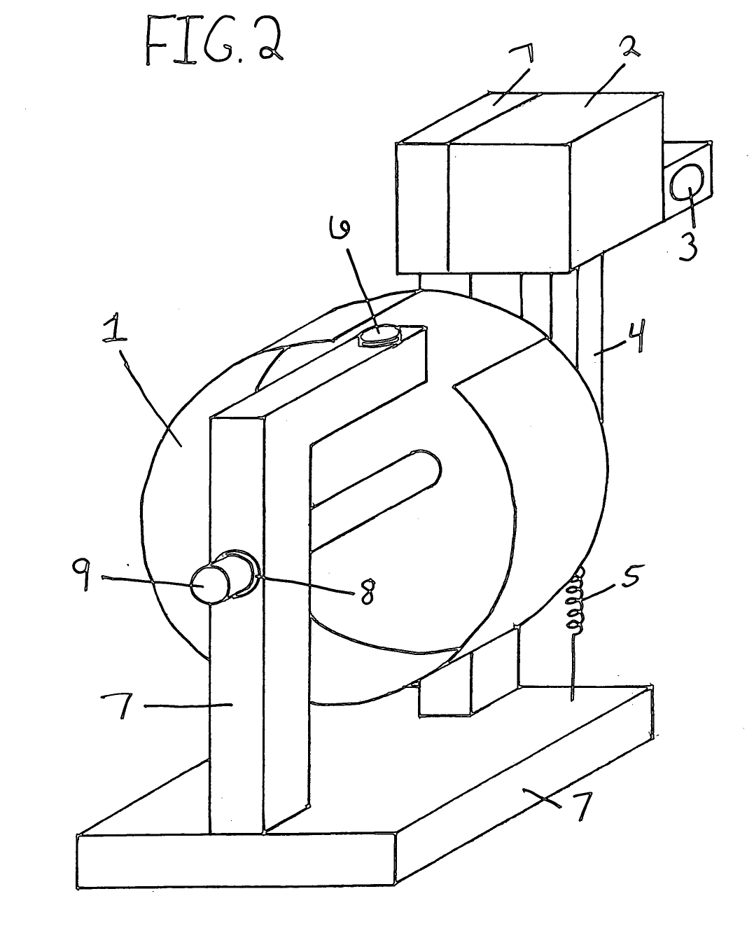

FIG. 2 shows a view of yet another configuration of a preferred embodiment of this invention in which the apparatus comprises a movable iron or steel shield cylinder 1 having one or more notches cut into the outer edge. The iron or steel shield cylinder 1 is mounted to a connecting shaft 9 which is mounted to a sleeve bearing 8 which is connected to an assembly structure 7. This preferred configuration allows rotational movement of iron or steel shield 1.

As shown in FIG. 2 Affixed to an assembly structure 7 is a fixed magnet 6 that can be shielded or exposed by the iron or steel shield cylinder 1. The iron or steel shield cylinder 1 is moved by an actuator, indexing motor or mechanical link 2. The iron or steel shield cylinder 1 is connected to an actuator, indexing motor or mechanical link 2 by an actuator, indexing motor or mechanical link connecting rod 4. A return spring 5 is used to return the iron or steel shield 1 to its disengaged position when the actuator, indexing motor or mechanical link 2 is disengaged.

As shown in FIG. 2 An electrical switch or mechanical trigger 3 is timed to control the actuator, indexing motor or mechanical link 2 at any time prior to or after any desired event.

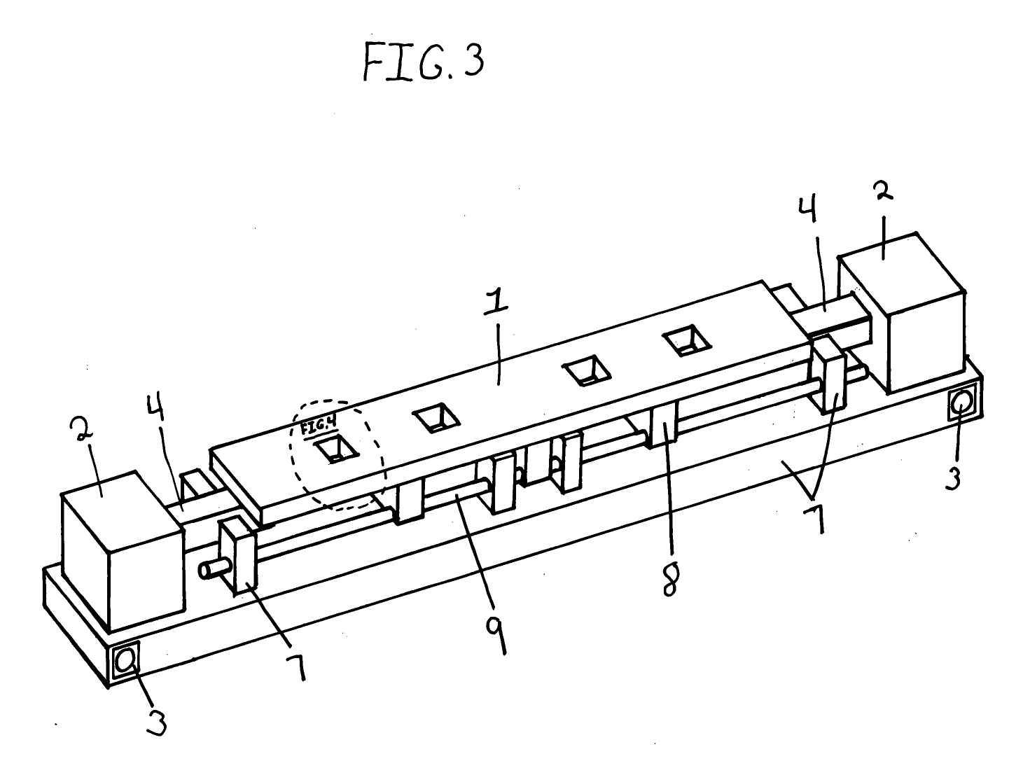

FIG. 3 shows a view of yet another configuration of a preferred embodiment of this invention in which the apparatus comprises a movable iron or steel shield plate 1 having one or more notches cut into it. The iron or steel shield plate 1 is mounted to linear bearings 8 which are connected to linear shafts 9 which are connected to the assembly structure 7. This preferred configuration allows linear movement of iron or steel shield plate 1.

As shown in FIG. 3 affixed to the assembly structure 7 is a fixed magnet 6 that can be shielded or exposed by the iron or steel shield plate 1. The iron or steel shield plate 1 is moved by an actuator, indexing motor or mechanical link 2. The iron or steel shield plate 1 is connected to an actuator, indexing motor or mechanical link 2 by an actuator, indexing motor or mechanical link connecting rod 4. A return actuator, indexing motor or mechanical link 2 is used to return the iron or steel shield plate 1 to its disengaged position when the actuator, indexing motor or mechanical link 2 on the opposing end of the iron or steel shield plate 1 is disengaged.

As shown in FIG. 3 an electrical switch or mechanical trigger 3 is timed to control the actuator, indexing motor or mechanical link 2 at any time prior to or after any desired event.

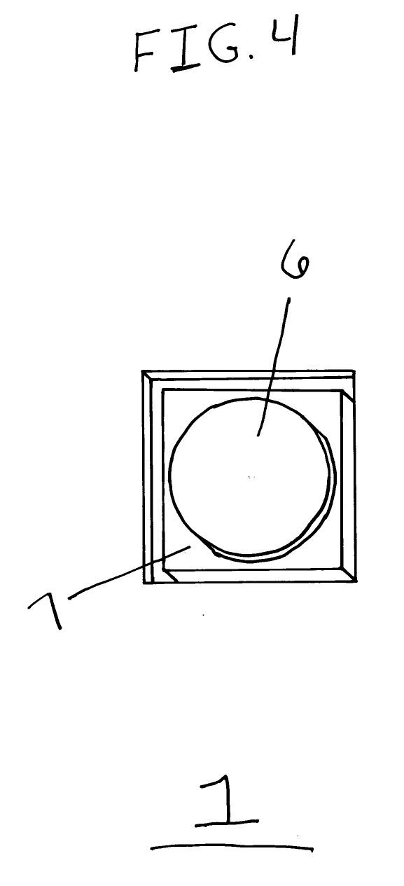

FIG. 4 shows a detailed view of the portion of FIG. 3 shown in a dotted circle. FIG. 4 shows an iron or steel shield plate 1, an assembly support 7 and a fixed position magnet.

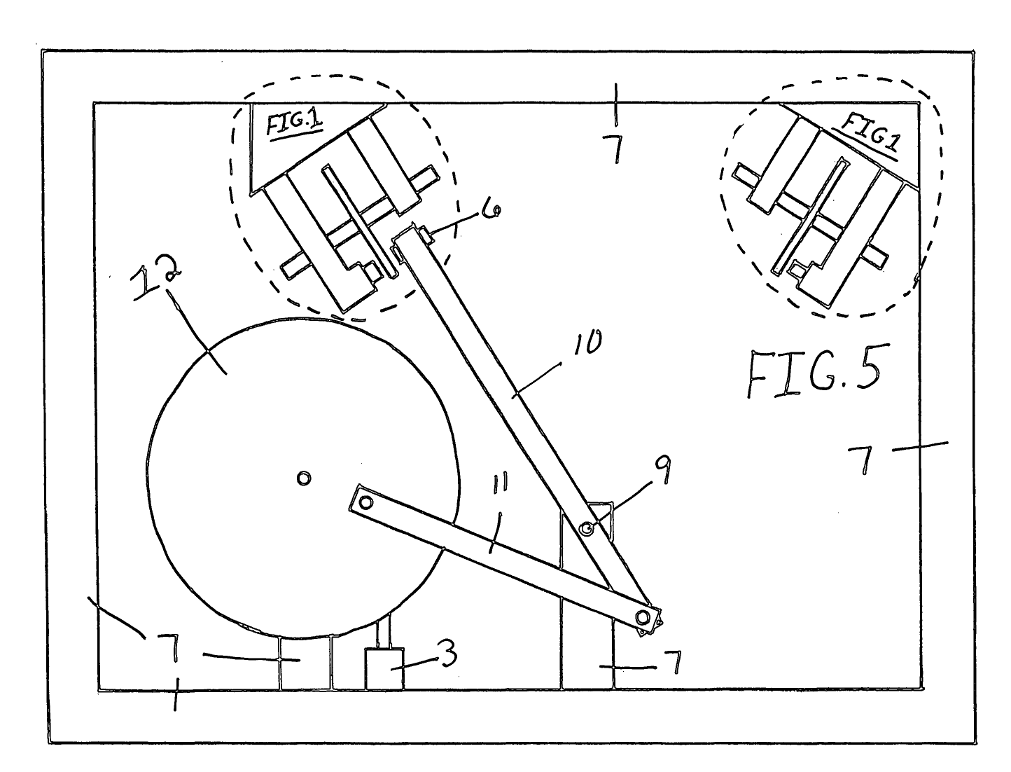

FIG. 5 shows a view of one configuration of the apparatus of this invention interacting with a simple mechanism. FIG. 1 is shown in a dotted circle. FIG. 5 shows a view of a preferred embodiment of this invention in which the apparatus comprises a movable iron or steel shield rotor 1 having one or more notches cut into the outer edge. The iron or steel shield rotor 1 is mounted to connecting shaft 9 which is mounted to a sleeve bearing 8 which is connected to an assembly structure 7. This preferred configuration allows rotational movement of iron or steel shield rotor 1.

As shown in FIG. 5 affixed to an assembly structure 7 is a fixed magnet 6 that can be shielded or exposed by iron or steel shield rotor 1. The iron or steel shield rotor 1 is moved by an actuator, indexing motor or mechanical link 2. The iron or steel shield rotor 1 is connected to an actuator, indexing motor or mechanical link 2 by an actuator, indexing motor or mechanical link connecting rod 4. A return spring 5 is used to return the iron or steel shield rotor 1 to its disengaged position when the actuator, indexing motor or mechanical link 2 is disengaged.

As shown in FIG. 5 an electrical switch or mechanical trigger 3 is timed to control the actuator, indexing motor or mechanical link 2 at any time prior to or after any desired

As shown in FIG. 5 the flywheel 12 is turned moving the power rod 10 back and forth. An electrical switch or mechanical trigger 3 is activated by the flywheel 12. An electrical switch or mechanical trigger activated by flywheel 12 activates an actuator, indexing motor or mechanical link 2 to engage iron or steel shield rotor 1. The iron or steel shield rotor engagement is timed to 0-90 degrees of flywheel rotation before or after full swing of power rod 10. As the power rod 10 comes closer to the disengaged iron or steel shield rotor 1 it is drawn to the disengaged iron or steel shield rotor 1 due to the attraction of the moveable magnet 6 to the disengaged iron or steel shield disc 1.

As shown in FIG. 5 at the end of the full swing of the power rod 10 and about 0-90 degrees of flywheel 12 rotation the electrical switch or mechanical trigger will activate the actuator, indexing motor or mechanical link 2 to engage the iron or steel shield rotor 1. At this time the two fixed position or moveable magnets 6 will be repelled due to opposite polarity. Because the fixed position or moveable magnets 6 and the iron or steel shield rotor 1 never touch the power required to engage the iron or steel shield rotor is minimal. Because the power rod 10 is always either being pushed or pulled by the fixed or moveable magnets 6 there is continual force being applied to the flywheel 12.

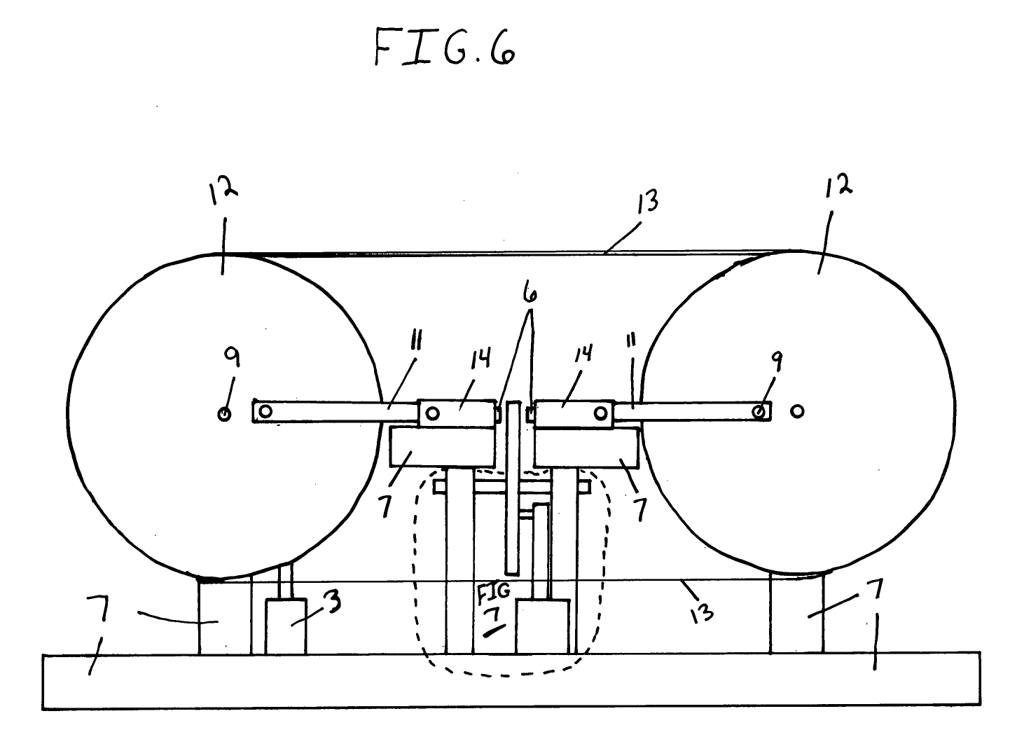

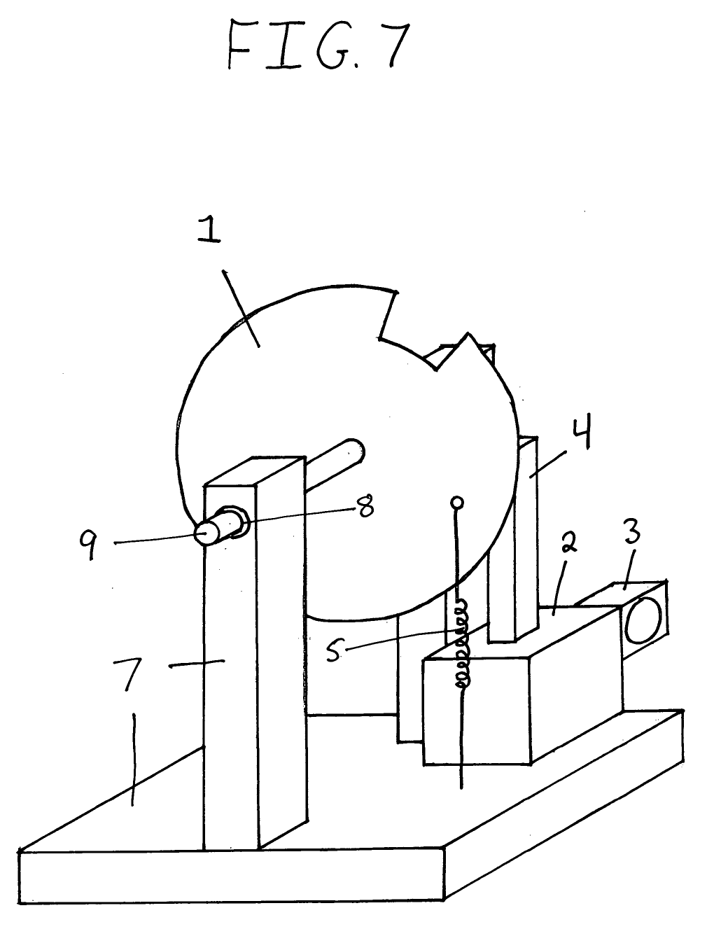

FIG. 6 shows a view of one configuration of the apparatus of this invention interacting with another simple mechanism. FIG. 7 is shown in a dotted circle. FIG. 6 shows a view of a preferred embodiment of this invention in which the apparatus comprises a movable iron or steel shield rotor 1 having one or more notches cut into the outer edge. The iron or steel shield rotor 1 is mounted to the connecting shaft 9 which is mounted to a sleeve bearing 8 which is connected to an assembly structure 7. This preferred configuration allows rotational movement of iron or steel shield 1.

As shown in FIG. 6 The iron or steel shield rotor 1 is moved by an actuator, indexing motor or mechanical link 2. The iron or steel shield rotor 1 is connected to an actuator, indexing motor or mechanical link 2 by an actuator, indexing motor or mechanical link connecting rod 4. A return spring 5 is used to return the iron or steel shield rotor 1 to its disengaged position when the actuator, indexing motor or mechanical link 2 is disengaged.

As shown in FIG. 6 an electrical switch or mechanical trigger 3 is timed to control the actuator, indexing motor or mechanical link 2 at any time prior to or after any desired event.

As shown in FIG. 6, the flywheels 12, which are synchronized by a timing belt, chain or gears 13, are turned moving the connecting rod 11 back and forth. An electrical switch or mechanical trigger activated by the flywheel 12 activates an actuator, indexing motor or mechanical link 2 to engage the iron or steel shield rotor 1. The iron or steel shield rotor 1 engagement is timed to 0-90 degrees of flywheel 12 rotation before or after full movement of connecting rod 11. As the connecting rod 11 comes closer to the disengaged iron or steel shield rotor 1 it is drawn to the disengaged iron or steel shield 1 due to the attraction of the moveable magnet 6 which is mounted to the moveable magnet guide 14.

As shown in FIG. 6, at the end of the full swing of the connecting rod 11 and about 0-90 degrees of flywheel 12 rotation the electrical switch or mechanical trigger 3 will activate the actuator, indexing motor or mechanical link 2 to engage the iron or steel shield rotor 1. At this time the two moveable magnets 6 will be repelled due to opposite polarity. Because the moveable magnets 6 and the iron or steel shield rotor 1 never touch the power required engaging the iron or steel shield rotor is minimal. Because the connecting rod 11 is always either being pushed or pulled by the moveable magnets 6 there is continual force being applied to the flywheel 12.

FIG. 7, shows a view of yet another configuration of a preferred embodiment of this invention in which the apparatus comprises a movable iron or steel shield rotor 1 having one or more notches cut into the outer edge. Iron or steel shield rotor 1 is mounted to a connecting shaft 9 which is mounted to a sleeve bearing 8 which is connected to an assembly structure 7. This preferred configuration allows rotational movement of iron or steel shield rotor 1.

As shown in FIG. 7, an iron or steel shield rotor 1 is moved by an actuator, indexing motor or mechanical link 2. The iron or steel shield rotor 1 is connected to actuator, indexing motor or mechanical link 2 by an actuator, indexing motor or mechanical link connecting rod 4. A return spring 5 is used to return the iron or steel shield rotor 1 to its disengaged position when the actuator, indexing motor or mechanical link 2 is disengaged.

As shown in FIG. 7, an electrical switch or mechanical trigger 3 is timed to control the actuator, indexing motor or mechanical link 2 at any time prior to or after any desired event.

This invention has been described in detail with particular reference to certain embodiments, but variations and modifications can be made without departing from the spirit and scope of the invention as defined in the following claims.

1. An apparatus for shielding or exposing permanent magnets, wherein the apparatus comprises: A. an iron or steel magnet shield that attracts magnets to it while hiding a magnet on the other side: B. an iron or steel magnet shield containing holes or openings to expose hidden or shielded magnet on the other side; C. an iron or steel magnet shield being moved by a power actuator, an indexing motor or by a mechanical link; D. a power actuator, an indexing motor or a mechanical link being activated by an electrical switch or mechanical link at a desired event.

2. An apparatus as defined by claim 1 wherein the iron or steel shield is a square shape.

3. An apparatus as defined by claim 1 wherein the iron or steel shield is a rectangle shape.

4. An apparatus as defined by claim 1 wherein the iron or steel shield is a round shape.

5. An apparatus as defined by claim 1 wherein the iron or steel shield is a cylindrical shape.

6. An apparatus as defined by claim 1 wherein the iron or steel shield is a conical shape.

7. An apparatus as defined by claim 1 wherein the iron or steel shield has one hole or slot for exposing said hidden magnet.

8. An apparatus as defined by claim 1 wherein the actuator, an indexing motor or a mechanical link is electrically powered.

9. An apparatus as defined by claim 1 wherein the actuator, an indexing motor or a mechanical link is pneumatically powered.

10. An apparatus as defined by claim 1 wherein the actuator, an indexing motor or a mechanical link is hydraulically powered.

11. An apparatus as defined by claim 1 wherein the actuator, an indexing motor or a mechanical link is powered by gravity.

12. An apparatus as defined by claim 1 wherein the actuator, an indexing motor or a mechanical link is powered by any type of fuel.

13. An apparatus as defined by claim 1 wherein any type of electric switch or mechanical trigger operates the actuator, an indexing motor or a mechanical link from any type of event.

14. A process for hiding a magnet until a desired event in order to apply magnetic energy to anything with a magnet of the opposite polarity attached to it.

15. A process as defined by claim 14 wherein magnetic energy is converted into mechanical force or kinetic energy.

16. A process as defined by claim 14 wherein magnetic energy is converted into electrical energy.
